(19) United States
(12) Patent Application Publication
(10) Pub. No.: US 2024/0386796 A1
(43) Pub. Date: Nov. 21, 2024

(54) SYSTEM AND METHOD OF CONTROLLING TRAFFIC SIGNAL

(71) Applicant: REXGEN CO., LTD., Anyang-si (KR)

(72) Inventor: Soon Hyun AHN, Anyang-si (KR)

(21) Appl. No.: 18/785,620

(22) Filed: Jul. 26, 2024

Related U.S. Application Data
(63) Continuation of application No. PCT/KR2023/001838, filed on Feb. 8, 2023.

(30) Foreign Application Priority Data
Feb. 21, 2022 (KR) 10-2022-0022535
May 3, 2022 (KR) 10-2022-0054723

(51) Int. Cl. G08G 1/01; G06V 20/54

(52) U.S. Cl. CPC G08G 1/0145; G06V 20/54; G06V 2201/08

(57) ABSTRACT

A system for controlling a traffic signal according to an embodiment of the disclosure includes an object detecting unit configured to detect object information based on a lane image, a capacity calculating unit configured to calculate accumulation capacity of each of objects for each of lanes included in a lane and an opposite lane of the lane based on the object information, an occupancy calculating unit configured to calculate occupancy of the lane and occupancy of the opposite lane based on the accumulation capacity of each of objects, and a cut line setting unit configured to set at least one cut line to the lane and the opposite lane based on the occupancy of the lane and the occupancy of the opposite lane.

### CROSS-REFERENCE TO RELATED APPLICATIONS

This application is a Bypass continuation of pending PCT International Application No. PCT/KR2023/001838, which was filed on Feb. 8, 2023, and which claims priorities under 35 U.S.C 119(a) to Korean Patent Application No. 10-2022-0022535 filed with the Korean Intellectual Property Office on Feb. 21, 2022, and Korean Patent Application No. 10-2022-0054723 filed with the Korean Intellectual Property Office on May 3, 2022. The disclosures of the above patent applications are incorporated herein by reference in their entirety.

### TECHNICAL FIELD

The disclosure relates to a system and a method of controlling a traffic signal.

### BACKGROUND ART

Research using results obtained by analyzing an image of a camera has been actively done in recent years. Specially, many researches and tries for optimizing and making efficient traffic flow by analyzing an image of a lane have been done in traffic field.

Conventional technique uses an optimal signal controlling method of detecting a vehicle in a lane image and calculating traffic volume by making data with the detected result, to realize a signal system for optimal traffic flow. However, the signal controlling method can't respond rapidly in a traffic situation changed in real time. Accordingly, it is necessary to establish a signal system for optimizing traffic flow by using real-time traffic information.

### SUMMARY

The disclosure is to provide a system and a method of controlling a traffic signal for calculating traffic volume and occupancy of a lane based on a lane image and setting a cut line on the basis of the calculated traffic volume and the calculated occupancy.

The disclosure is to provide a system and a method of controlling a traffic signal for optimizing traffic flow using real-time traffic information obtained by analyzing the lane image.

Aspects of the disclosure are not limited as aspects mentioned above, and another aspect not mentioned will be clearly understood by a person in the art from following description.

A system for controlling a traffic signal according to an embodiment of the disclosure includes an object detecting unit configured to detect object information based on a lane image; a capacity calculating unit configured to calculate accumulation capacity of each of objects for each of lanes included in a lane and an opposite lane of the lane based on the object information; an occupancy calculating unit configured to calculate occupancy of the lane and occupancy of the opposite lane based on the accumulation capacity of each of objects; and a cut line setting unit configured to set at least one cut line to the lane and the opposite lane based on the occupancy of the lane and the occupancy of the opposite lane.

In an embodiment, the capacity calculating unit gives traffic capacity of each of objects based on a type, a number and an order of the object and calculates the accumulation capacity of each of objects on the basis of traffic capacity of each of objects.

In an embodiment, the capacity calculating unit gives traffic capacity of each of objects based on a capacity correction factor and calculates the accumulation capacity of each of objects on the basis of traffic capacity of each of objects.

In an embodiment, the capacity calculating unit corrects the accumulation capacity further considering at least one of heavy vehicle ratio, a waiting order for each of lanes, a distribution for each of types of the object, a slope of a road, a linear shape of the road, a branch of the road and a junction of the road.

In an embodiment, the occupancy calculating unit calculates the occupancy corresponding to each of the accumulation capacities based on whether an object corresponding to each of accumulation capacities exists on each of lanes.

In an embodiment, the occupancy calculating unit assigns occupancy corresponding to each of lanes, and calculates the occupancy corresponding to each of accumulation capacities based on occupancy assigned to a lane on which an object corresponding to each of accumulation capacities exists.

In an embodiment, the occupancy calculating unit estimates that an object corresponding to each of accumulation capacities exists when an object corresponding to each of accumulation capacities does not exist but an object corresponding to accumulation capacity greater than each of accumulation capacities exists, and calculates the occupancy depending on the estimating.

In an embodiment, the cut line setting unit calculates total occupancy corresponding to each of accumulation capacities by summating occupancy of the lane corresponding to each of accumulation capacities and occupancy of the opposite lane corresponding to each of accumulation capacities, and sets at least one object corresponding to accumulation capacity, which is more than reference accumulation capacity and its total occupancy is more than specific occupancy, as the at least one cut line.

In an embodiment, the cut line setting unit sets one or more objects corresponding to multiple accumulation capacities, which are more than reference accumulation capacity and their total occupancy is more than specific occupancy, as the at least one cut line.

In an embodiment, the system further includes a controller configured to set any one of the at least one cut line as a final cut line.

In an embodiment, the controller sets the final cut line based on traffic situation or environment information.

In an embodiment, the environment information includes one or more of a pedestrian waiting line of a crosswalk, arrival of a vehicle group in previous intersection or not, sharp increase of a vehicle or not and information concerning accumulation capacity of another lane.

In an embodiment, the controller generates a control signal for controlling a signal time of a signal controller based on the final cut line.

In an embodiment, the system further includes a template generating unit configured to generate a first template corresponding to the lane and a second template corresponding to the opposite lane based on the object information, and generate a template by disposing side by side the first template and the second template in a width direction.

In an embodiment, the system further includes a simulation unit configured to display the generated template and provide a traffic simulation in the template.

In an embodiment, the simulation unit displays the template with a user interface (UI) of setting a cut line.

In an embodiment, the opposite lane includes at least one lane passable at a simultaneous entry signal of an intersection between the lane and the intersection.

A method of controlling a traffic signal according to an embodiment of the disclosure includes detecting object information based on a lane image; calculating accumulation capacity of each of objects for respective lane included a lane and an opposite lane of the lane based on the object information; calculating occupancy of the lane and occupancy of the opposite lane based on the accumulation capacity of each of objects; and setting at least one cut line to the lane and the opposite lane based on the occupancy of the lane and the occupancy the opposite lane.

A system and a method of controlling a traffic signal according to an embodiment of the disclosure may set a cut line related to traffic volume and occupancy of a lane and calculate a time required when an object passes through a stop line or an intersection (or a green signal time of a traffic light) based on the set cut line.

A system and a method of controlling a traffic signal according to an embodiment of the disclosure may vary the cut line depending on traffic volume of the lane changed in real time, thereby maximizing real-time traffic flow and traffic efficiency.

A system and a method of controlling a traffic signal according to an embodiment of the disclosure may set the cut line for each of lanes based on passage information including information of objects located on the lane and control efficiently the traffic flow by learning the time required when an object passes through the stop line or the intersection (or the green signal time of the traffic light), the time corresponding to the cut line.

Additionally, various effects perceived directly or indirectly through the disclosure may be provided.

### BRIEF DESCRIPTION OF DRAWINGS

FIG. 1 is a view illustrating environment of a system for controlling a traffic signal according to an embodiment of the disclosure;

FIG. 2 is a view illustrating an example of obtaining a lane image using a system for controlling a traffic signal according to an embodiment of the disclosure;

FIG. 3 is a view illustrating an example of a lane image obtained by using a system for controlling a traffic signal according to an embodiment of the disclosure;

FIG. 4 is a block diagram illustrating a system for controlling a traffic signal according to an embodiment of the disclosure;

FIG. 5 is a view illustrating an example of calculating accumulation capacity using a system for controlling a traffic signal according to an embodiment of the disclosure;

FIG. 6 is a view illustrating an example of calculating occupancy based on accumulation capacity in a system for controlling a traffic signal according to an embodiment of the disclosure;

FIG. 7 is a view illustrating an example of setting a cut line using a system for controlling a traffic signal according to an embodiment of the disclosure;

FIG. 8 is a view illustrating an example of setting a final cut line using a system for controlling a traffic signal according to an embodiment of the disclosure;

FIG. 9 is a view illustrating an example of generating a template using a system for controlling a traffic signal according to an embodiment of the disclosure; and

FIG. 10 is a flowchart illustrating a process of controlling a traffic signal according to an embodiment of the disclosure.

### DETAILED DESCRIPTION

Hereinafter, embodiments of the disclosure will be described in detail with reference to accompanying drawings. It should be understood that the same numbers refer to the same elements throughout the description of the figures. Detailed description concerning related known constitution or function will be omitted if it is determined that the related known constitution or function hinders understanding of embodiments of the disclosure.

It will be understood that, although the terms first, second, A, B, (a), (b), etc. may be used herein to describe various elements, these elements should not be limited by these terms. These terms are only used to distinguish one element from another. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

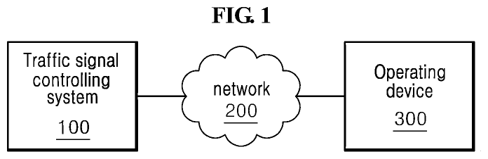

FIG. 1 is a view illustrating environment of a system for controlling a traffic signal according to an embodiment of the disclosure.

In FIG. 1, a system 100 for controlling a traffic signal according to present embodiment may communicate with an operating device 300 through a network 200.

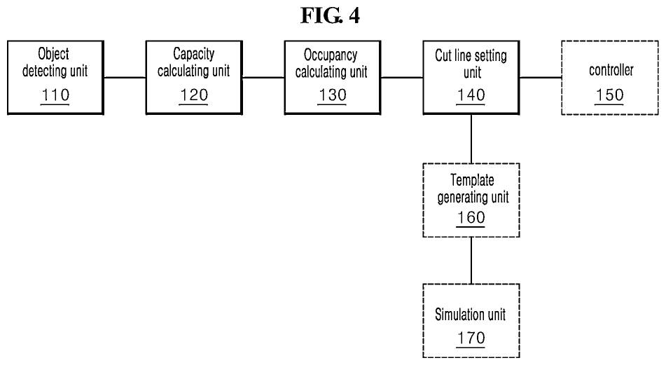

In an embodiment, the system 100 may transmit information related to at least one of an object detected by an object detecting unit 110, accumulation capacity calculated by a capacity calculating unit 120, occupancy calculated by an occupancy calculating unit 130, a cut line set by a cut line setting unit 140 and a signal time controlled by a controller 150, as shown in FIG. 4, to the operating device 300. Additionally, the system 100 may transmit further a template generated by a template generating unit 160 shown in FIG. 4 to the operating device 300.

The operating device 300 may control traffic flow of a lane based on information received from the system 100. In an embodiment, the system 100 may be included in the operating device 300. In another embodiment, the operating device 300 may include one or more elements of the system 100. For example, the operating device 300 may include a simulation unit 170 of the system 100.

In an embodiment, the operating device 300 may display a template through a user interface (UI). A user (operator or manager) may identify intuitively a waiting line of the lane based on the template displayed through the operating device 300.

In an embodiment, the user (operator or manager) may place randomly a block-type object in the template displayed through the user interface (UI) of the operating device 300. In this case, the user may simulate setting of the cut line and signal control through the operating device 300.

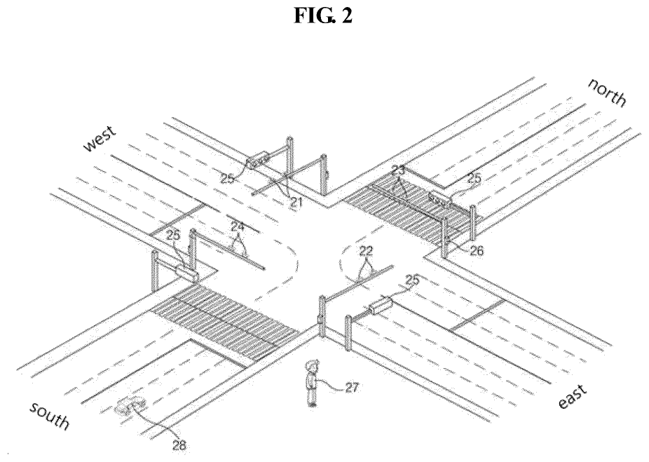

FIG. 2 is a view illustrating an example of obtaining a lane image using a system for controlling a traffic signal according to an embodiment of the disclosure.

In FIG. 2, a system for controlling a traffic signal (for example a system 100 for controlling a traffic signal in FIG. 4) of the present embodiment may obtain a lane image. For example, a lane may include an intersection, and the system for controlling the traffic signal (for example the system 100 in FIG. 4) may obtain the lane image from an image photographing device 21, 22, 23 or 24 located on the intersection. In an embodiment, the image photographing device 21, 22, 23 or 24 may include a camera or an image sensor.

In an embodiment, a first image photographing device 21 may photograph a lane located in the east, a second image photographing device 22 may photograph a lane located in the west, a third image photographing device 23 may photograph a lane located in the south, and a fourth image photographing device 24 may photograph a lane located in the north. FIG. 2 illustrates an intersection (four-way stop), but it is not limited as the intersection. The intersection may mean a lane including a place at which two or more entry/exit lanes using a traffic signal system meet. For example, the intersection may indicate bidirectional lane including a pedestrian crossing signal system and a crosscut lane as well as a three-way intersection, a four-way intersection or a five-way intersection used commonly.

The image photographing device 21, 22, 23 or 24 may photograph an object 27 or 28 on a road. For example, the object on the road may include a pedestrian 27 and a vehicle 28.

In an embodiment, the system for controlling the traffic signal (for example the system 100 in FIG. 4) may be included in at least one of a signal light 25, a signal controller 26, the image photographing device 21, 22, 23 or 24 and an operating device 300. However, it is not limited. The system for controlling the traffic signal (for example the system 100 in FIG. 4) may be included in an external server or exist as an extra device.

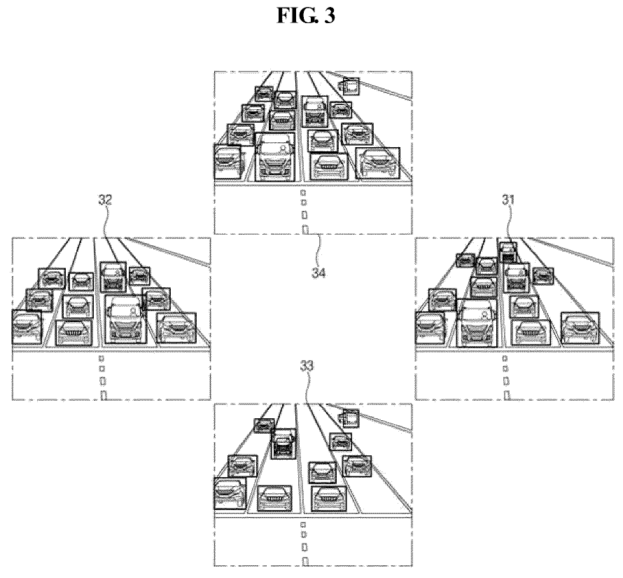

FIG. 3 is a view illustrating an example of a lane image obtained by using a system for controlling a traffic signal according to an embodiment of the disclosure.

In FIG. 3, a system for controlling a traffic signal (for example the system 100 in FIG. 4) of the present embodiment may obtain images 31, 32, 33 and 34 photographed by the image photographing device in FIG. 2. For example, the system for controlling the traffic signal (the system 100 in FIG. 4) may receive a first image 31 obtained by photographing east of a lane using a first image photographing device (for example the first image photographing device 21 in FIG. 2) from the first image photographing device and receive a second image 32 obtained by photographing west of the lane using a second image photographing device (for example the second image photographing device 22 in FIG. 2) from the second image photographing device.

In an embodiment, the first image 31 and the second image 32 may be images of lanes facing each other. For example, the second image 32 may be an image of an opposite lane of a lane of the first image 31 when the first image 31 is an image of the lane in the east. For example, the second image 32 may be an image of the lane in the west. Furthermore, the third image 33 and the fourth image 34 may be images of lanes facing each other. In an embodiment, the opposite lane is reverse concept of conflict and may mean at least one lane passable at simultaneous entry signal in the intersection.

The system for controlling the traffic signal (for example the system 100 in FIG. 4) may detect an object based on the image 31, 32, 33 or 34 photographed by the image photographing device, generate a template and control a traffic signal by setting a cut line.

FIG. 4 is a block diagram illustrating a system for controlling a traffic signal according to an embodiment of the disclosure.

In FIG. 4, the system 100 for controlling the traffic signal of the present embodiment may include the object detecting unit 110, the capacity calculating unit 120, the occupancy calculating unit 130 and the cut line setting unit 140. In an embodiment, the system 100 may include further the controller 150. In another embodiment, the system 100 may include further the template generating unit 160 and the simulation unit 170.

The object detecting unit 110 may detect object information based on a lane image. For example, the object detecting unit 110 may detect an object included in a lane and passage information based on the lane image. In an embodiment, the passage information may comprise object information (for example including type of a vehicle such as a sedan, a van, a bus, a truck, etc. and size of the vehicle such as small size, medium size, large size, etc.) for each of lanes, the number of the vehicle and a waiting order when the object is the vehicle. In an embodiment, the passage information may include further one or more of a distance between vehicles, a vehicle number, a color of the vehicle, stop or not and driving or not. In an embodiment, the object may include the vehicle, a pedestrian, a traffic facility and so on. In an embodiment of the present disclosure, the object may be a vehicle.

In an embodiment, the lane image may include an entry lane image of the intersection. For example, the object detecting unit 110 may obtain the lane image from the image photographing device 21, 22, 23 or 24 established at the intersection. For another example, the object detecting unit 110 may detect an object on multiple lanes. For still another example, the object detecting unit 110 may detect a vehicle based on an intersection entry lane image obtained by photographing the front of the vehicle located in an entry direction of the intersection. In an embodiment, the object detecting unit 110 may detect the rear of a vehicle on the basis of an intersection exit lane image obtained by photographing the vehicle driven in an exit direction of the intersection, except the vehicle located in the entry direction of the intersection.

The object detecting unit 110 may provide the passage information detected in the lane image to another object detecting unit established at next intersection in a driving direction of the vehicle or adjacent intersection. In an embodiment, another element (for example the controller 150) in the system 100 for controlling the traffic signal may provide the passage information detected by the object detecting unit 110 to another system for controlling the traffic signal established at next intersection in the driving direction of the vehicle or adjacent intersection.

The capacity calculating unit 120 may calculate accumulation capacity of the object for each of lanes included in the lane and an opposite lane of the lane based on the object information. For example, the opposite lane may include at least one lane passable at a simultaneous entry signal of the intersection between the lane and the intersection. For another example, the opposite lane may include a lane in an opposite direction of the lane.

In an embodiment, the capacity calculating unit 120 may calculate accumulation capacity of an object for each of lanes based on type, number and order of the object. For example, the capacity calculating unit 120 may calculate the accumulation capacity of each of objects by giving traffic capacity greater than traffic capacity of a small size vehicle to a large size vehicle

In an embodiment, the capacity calculating unit 120 may give traffic capacity of each of objects based on a capacity correction factor and calculate accumulation capacity of each of objects depending on the traffic capacity of each of objects. For example, the capacity correction factor may include a heavy vehicle correction factor or a sedan scale factor. For another example, the capacity calculating unit 120 may set respectively 1, 2 and 3 to a small size vehicle, a medium size vehicle and a large size vehicle in view of weight and calculate the accumulation capacity depending on the setting. However, a method of calculating the accumulation capacity is not limited as the method mentioned above. The capacity calculating unit 120 may set different weight according to a type of the object and calculate the accumulation capacity depending on the setting.

In an embodiment, the capacity calculating unit 120 may calculate the accumulation capacity of each of object according to the traffic capacity given to each of objects based on the capacity correction factor. r. For example, the capacity calculating unit 120 may calculate accumulation capacity of a target object by summating traffic capacity of the target object and traffic capacity of an object waiting in front of the target object in a direction of a stop line on the basis of the target object.

In an embodiment, the capacity calculating unit 120 may correct the accumulation capacity further considering at least one of heavy vehicle ratio, waiting order for each of lanes, distribution for each of types of objects, slope of a road, linear shape of a road, branch of the road and junction of the road.

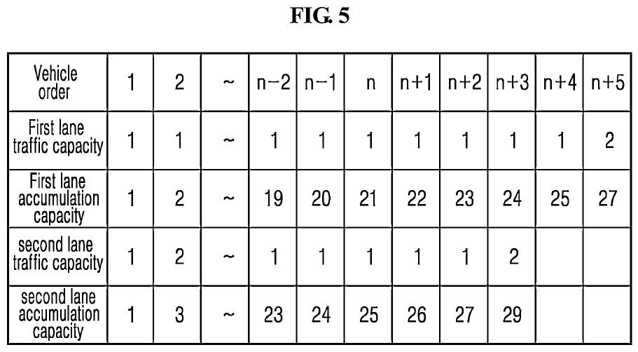

FIG. 5 is a view illustrating an example of calculating accumulation capacity using a system for controlling a traffic signal according to an embodiment of the disclosure.

In FIG. 5, the capacity calculating unit 120 in the system 100 for controlling the traffic signal according to the present embodiment may include accumulation capacity of an object for each of lanes. For example, the capacity calculating unit 120 may calculate accumulation capacity of each of objects waiting on a first lane and accumulation capacity of each of objects waiting on a second lane when two lanes exist.

FIG. 5 shows a case that two lanes exist, but it is not limited. The capacity calculating unit 120 may calculate accumulation capacity of each of objects for x lane when x lane exists.

Now referring to FIG. 4, the occupancy calculating unit 130 may calculate occupancy of a lane and occupancy of an opposite lane based on accumulation capacity of each of objects waiting on respective lane. For example, the occupancy calculating unit 130 may calculate occupancy corresponding to each of accumulation capacity based on whether an object corresponding to reference accumulation capacity and accumulation capacity greater than the reference accumulation capacity exists on each of the lanes. In an embodiment, the reference accumulation capacity may be calculated by using a theoretical calculation method for realizing maximum traffic flow in road design, (e.g., intersection design) or an empirical method considering normal traffic flow of a road, etc., and it may mean accumulation capacity corresponding to a green signal time preset by a signal controller. Here, the green signal time may be identical to a time elapsed for passing a stop line or the intersection.

In an embodiment, the occupancy corresponding to each of accumulation capacities calculated by the occupancy calculating unit 130 may be limited as occupancy corresponding to specific accumulation capacity.

In an embodiment, the occupancy calculating unit 130 may assign occupancy corresponding to each of lanes. For example, the occupancy calculating unit 130 may assign evenly the occupancy of each of lanes according to the number of a lane or assign differently the occupancy of each of lanes depending on specific time or environment information. In an embodiment, the occupancy calculating unit 130 may assign 50% occupancy for each of lanes when two lanes exist. For another example, the occupancy calculating unit 130 may assign 25% occupancy for each of lanes when four lanes exist. On the other hand, the same occupancy may not be assigned to each of lanes. In the event that two lanes exist, the occupancy calculating unit 130 may assign 30% occupancy to a first lane of the lanes and assign 70% occupancy to a second lane of the lanes. In an embodiment, the occupancy calculating unit 130 may assign occupancy corresponding to each of lanes based on a time or environment information.

In an embodiment, the occupancy calculating unit 130 may calculate occupancy corresponding to each of accumulation capacities based on occupancy assigned to a lane on which an object corresponding to each of accumulation capacities exist. For example, the occupancy calculating unit 130 may summate occupancies assigned to lanes on which an object corresponding to each of accumulation capacities exists and calculate occupancy corresponding to each of occupancy capacities based on the summating.

In an embodiment, the occupancy calculating unit 130 may determine that an object corresponding to each of accumulation capacities exist when the object corresponding to each of accumulation capacities does not exist but an object corresponding to accumulation capacity greater than each of accumulation capacities exists. For example, the occupancy calculating unit 130 may determine that the object corresponding to each of accumulation capacities exists and calculate occupancy by estimating occupancy depending on the determined result.

In an embodiment, the occupancy calculating unit 130 may calculate occupancy by giving different weight to the occupancy assigned to each of lanes, or calculate occupancy through various methods such as sum, average, weighed average or multiplication of occupancies assigned to each of lanes or feature extraction of traffic capacity.

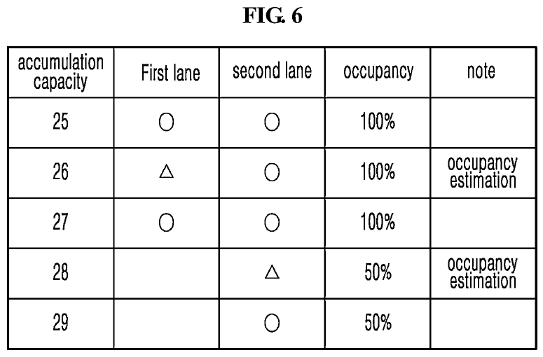

FIG. 6 is a view illustrating an example of calculating occupancy based on accumulation capacity in a system for controlling a traffic signal according to an embodiment of the disclosure.

In FIG. 5 and FIG. 6, the occupancy calculating unit 130 may calculate occupancy corresponding to each of accumulation capacities. For example, the occupancy calculating unit 130 may calculate occupancy corresponding to accumulation capacity more than 25 which is reference accumulation capacity. For another example, the occupancy calculating unit 130 may determine the occupancy to 100% because objects exist on both of the first lane and the second lane when the accumulation capacity is 25. For still another example, since an object corresponding to accumulation capacity 26 does not exist on the first lane but an object corresponding to accumulation capacity 27 exists on the first lane when the accumulation capacity is 26, the occupancy calculating unit 130 may determine that the object corresponding to the accumulation capacity 26 exists. Additionally, the occupancy calculating unit 130 may determine (estimate) occupancy to 100% because an object corresponding to accumulation capacity 26 exists on the second lane. For still another example, since corresponding object does not exist on the first lane and exists on the second lane when the accumulation capacity is 29, the occupancy calculating unit 130 may determine the occupancy to 50%. This is a case that 50% occupancy is assigned to the first lane and the second lane, respectively. However, the occupancy calculating unit 130 may assign different occupancy to the first lane and the second lane and calculate occupancy based on the assigning.

Now referring to FIG. 4, the cut line setting unit 140 may set at least one cut line to the lane and the opposite lane based on occupancy of the lane and occupancy of the opposite lane. For example, the cut line setting unit 140 may calculate total occupancy by summating occupancy of the lane corresponding to each of accumulation capacities and occupancy of the opposite lane corresponding to each of accumulation capacities. Moreover, the cut line setting unit 140 may set accumulation capacity, which is more than reference accumulation capacity and its total occupancy is more than specific occupancy, as at least one cut line. In an embodiment, the cut line setting unit 140 may set an object for each of lanes corresponding to the accumulation capacity, which is more than reference accumulation capacity and its total occupancy is more than specific occupancy, as a cut line.

In an embodiment, the cut line setting unit 140 may set at least one object corresponding to multiple accumulation capacities, which are more than reference accumulation capacity and their total occupancy is more than specific occupancy, as at least one cut line.

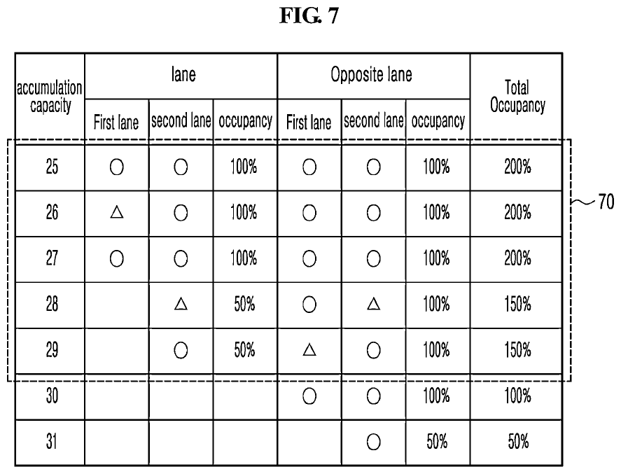

FIG. 7 is a view illustrating an example of setting a cut line using a system for controlling a traffic signal according to an embodiment of the disclosure.

In FIG. 7, the cut line setting unit 140 may calculate total occupancy by summating occupancy of the lane corresponding to accumulation capacity and occupancy of the opposite lane corresponding to the accumulation capacity. For example, the cut line setting unit 140 may determine total occupancy to 200% by summating occupancy 100% of the lane corresponding to accumulation capacity 25 and occupancy 100% of the opposite lane corresponding to the accumulation capacity 25. For another example, the cut line setting unit 140 may determine total occupancy to 150% by summating occupancy 50% of the lane corresponding to accumulation capacity 29 and occupancy 100% of the opposite lane corresponding to the accumulation capacity 29.

The cut line setting unit 140 may set accumulation capacity, which is more than reference accumulation capacity and its total occupancy is more than specific occupancy, as at least one cut line. For example, the cut line setting unit 140 may set at least one object corresponding to accumulation capacity in a range of 25 to 29 as at least one cut line 70.

Now referring to FIG. 4, the system 100 for controlling the traffic signal of the present embodiment may include further the controller 150.

The controller 150 may set any one of at least one cut line as a final cut line. For example, the controller 150 may set the final cut line based on traffic situation or environment information of pposite lane. In an embodiment, the opposite lane may mean an opposite lane in a single intersection or an opposite lane of another intersection such as previous intersection or sequential intersection, etc. In an embodiment, the environment information may include at least one of a pedestrian waiting line of a crosswalk, arrival of vehicle group in previous intersection or not, sharply increasing of vehicles or not and information concerning accumulation capacity of another lane.

In an embodiment, the controller 150 may generate a control signal for controlling a signal time of a signal controller based on the final cut line. For example, the controller 150 may obtain a time elapsed for passing a stop line or the intersection (or a green signal time of a signal light) corresponding to the final cut line, and generate the control signal depending on the obtained time. For example, the controller 150 may store information concerning a time elapsed for passing the stop line or the intersection preset for each of accumulation capacities of an object, and obtain the green signal time needed for passing the stop line or the intersection corresponding to accumulation capacity of an object corresponding to the final cut line by using the stored information. It is desirable to calculate the time elapsed for passing the stop line or the intersection, i.e., the green signal time based on minimal signal time greater than 0 second. This is because a green signal of corresponding lane is skipped if the signal controller performs control operation while the green signal time is 0 second, thereby bringing out practically confusion of a traffic system.

In an embodiment, the controller 150 may correct reference accumulation capacity and specific occupancy based on traffic situation or environment information of opposite lane, the reference accumulation capacity being a reference for setting the cut line by the cut line setting unit 140. For example, the specific occupancy may include occupancy calculated through the occupancy calculating unit 130. For another example, the specific occupancy may include reference occupancy for setting the cut line by the cut line setting unit 140.

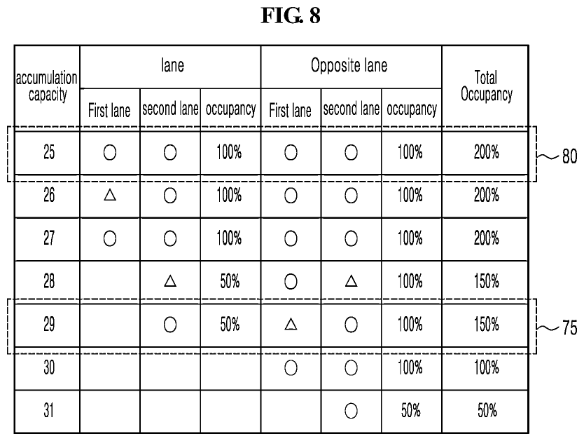

FIG. 8 is a view illustrating an example of setting a final cut line using a system for controlling a traffic signal according to an embodiment of the disclosure.

In FIG. 8, the controller 150 may set any one of one or more cut lines 70 generated by the cut line setting unit 140 in FIG. 7 as a final cut line. For example, the controller 150 may set a cut line 80 corresponding to accumulation capacity 25 as the final cut line when many objects exist on an opposite lane. In another example, the controller 150 may set a cut line 75 corresponding to accumulation capacity 29 as the final cut line when a few of objects exist on the opposite lane.

Now referring to FIG. 4, the system 100 for controlling the traffic signal according to the present embodiment may include further the template generating unit 160 and the simulation unit 170.

The template generating unit 160 may generate a first template corresponding to a lane and a second template corresponding to an opposite lane based on object information. Additionally, the template generating unit 160 may generate a template by disposing side by side the first template and the second template in a width direction. For example, the template generating unit 160 may generate a template by disposing adjacently the first template and the second template top-bottom or left-right. In an embodiment, the width direction may include a direction vertical to a width direction of the lane or a driving direction of the object.

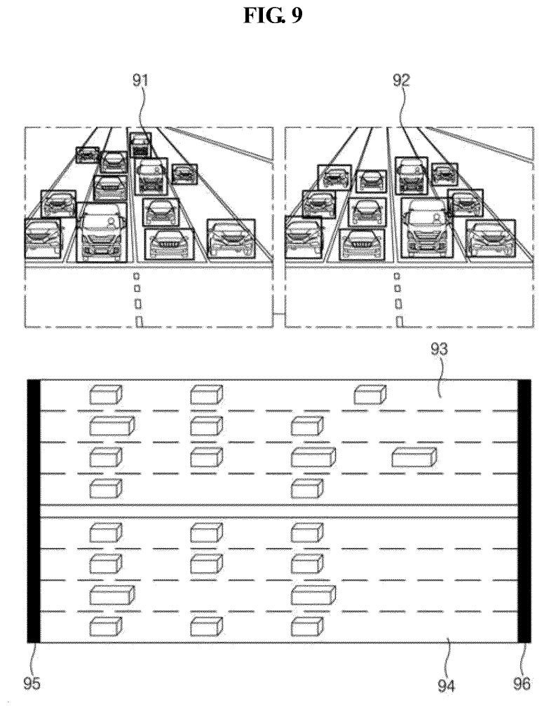

FIG. 9 is a view illustrating an example of generating a template using a system for controlling a traffic signal according to an embodiment of the disclosure.

In FIG. 9, the object detecting unit 110 of the system 100 for controlling the traffic signal according to the present embodiment may detect an object from a lane image 91 or 92. For example, the object detecting unit 110 may detect the object from the first image 91 and the second image 92. In an embodiment, the first image 91 may be substantially identical to the first image 31 in FIG. 3, and the second image 92 may be substantially identical to the second image 32 in FIG. 3. In another embodiment, the first image 91 may be substantially identical to the third image 33 in FIG. 3, and the second image 92 may be substantially identical to the fourth image 34 in FIG. 3. That is, the system 100 may detect an object from an image concerning the lane and the opposite lane.

The template generating unit 160 of the system 100 may generate the template based on the first image 91 and the second image 92. For example, the template generating unit 160 may generate a first template 93 using the first image 91 and generate a second template 94 based on the second image 92. In this case, the template generating unit 160 may generate a template by disposing side by side the first template 93 and the second template 94 in a width direction.

In an embodiment, the template generating unit 160 may generate a template by matching a stop line of the first template 93 with a stop line of the second template 94. For example, the template generating unit 160 may match a start point 95 and an end point 96 of the first template 93 and the second template 94. Accordingly, a user (operator) may compare or verify intuitively a length of a waiting line of an object based on the template displayed through the simulation unit 170.

In an embodiment, the template generating unit 160 may generate a template indicating imaginary opposite lane by converting an image, e.g. first image 91 of a first intersection entry lane and an image, e.g. second image 92 of a second intersection entry lane in a vertical viewpoint, normalizing objects detected from the image, e.g. first image 91 of the first intersection entry lane and the image, e.g. second image 92 of the second intersection entry lane and disposing again the normalized objects.

In an embodiment, the template generating unit 160 may generate a template by normalizing the object detected by the object detecting unit 110 in a figure based on passage information. For example, the figure may include a block shape. For another example, the template generating unit 160 may convert the object into a block with a size corresponding to objection information. In an embodiment, the template generating unit 160 may convert an object such as a bus or a truck into a block having a size greater than a block of a sedan having relatively small size. In an embodiment, the template generating unit 160 may convert the object into a block with preset size based on the object information. In an embodiment, the template generating unit 160 may convert an environmental object such as a lane, a lane marking, various traffic facilities or geometrical road structure (for example slope, linear shape, branch, junction, etc.) in a digital twin by 3D-modeling the environmental object. In this case, the template generating unit 160 may reduce resource of a processor by converting simply the environmental object into a block.

The simulation unit 170 may display the template generated by the template generating unit 160, provide traffic simulation showing driving, etc. of an object in the template and provide a traffic signal control simulation function in the digital twin, the traffic signal control simulation function including an UI of generating the template and setting a cut line to the template by interworking with the cut line setting unit according to a user's control. In an embodiment, the simulation unit 170 may not be included in the system 100 for controlling the traffic signal but included in the operating device 300 in FIG. 1. For example, the simulation unit 170 may dispose top-bottom or left-right the first image and the second image corresponding to the lane or the opposite lane or dispose selectively the first template and the second template on a top part, a bottom part, a left part or a right part of the first image and the second image when it displays through a traffic signal control simulation. In this case, a driving direction of an object, e.g., vehicle in each of the templates may be displayed in a direction selected from a group including a direction from right to left, a direction from left to right, a direction from top to bottom and a direction from bottom to top according to a location of each of templates.

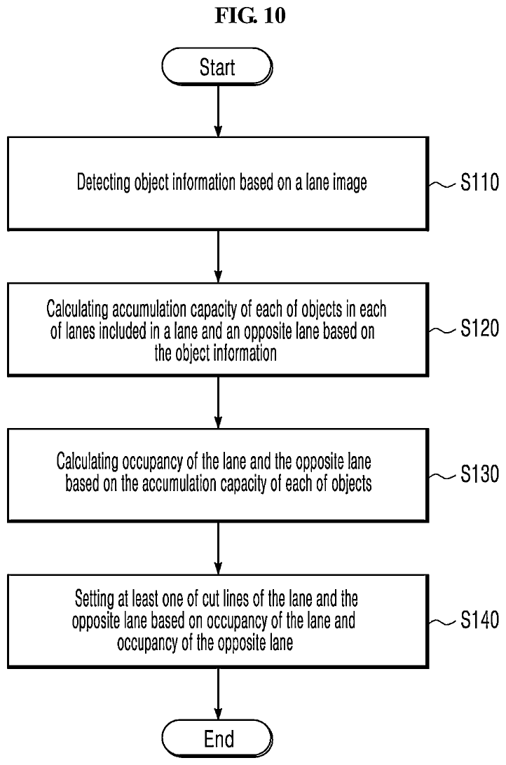

FIG. 10 is a flowchart illustrating a process of controlling a traffic signal according to an embodiment of the disclosure.

In FIG. 10, in a step of S110, the object detecting unit 110 may detect an object based on a lane image.

In a step of S120, the capacity calculating unit 120 may calculate accumulation capacity of an object for each of lanes included in a lane and an opposite lane based on object information.

In a step of S130, the occupancy calculating unit 130 may calculate occupancy of the lane and occupancy of the opposite lane based on accumulation capacity of each of objects.

In a step of S140, the cut line setting unit 140 may set at least one cut line to the lane and the opposite lane based on the occupancy of the lane and the occupancy of the opposite lane. For example, the cut line setting unit 140 may set at least one cut line corresponding to one or more objects located on the lane and the opposite lane.

Although embodiments have been described with reference to a number of illustrative embodiments thereof, it should be understood that numerous other modifications and embodiments can be devised by those skilled in the art that will fall within the spirit and scope of the principles of this disclosure.

Accordingly, embodiments in the disclosure are for explaining technical thought not limiting the technical thought, and a range of the technical thought disclosed in the disclosure is not limited by the embodiments. Protection scope of the technical thought disclosed in the disclosure is interpreted by following claims, and it will be interpreted that every equivalent technical thought is included in right scope of the disclosure.

What is claimed is:

1. A system for controlling a traffic signal comprising:
an object detecting unit configured to detect object information based on a lane image;
a capacity calculating unit configured to calculate accumulation capacity of each of objects for each of lanes included in a lane and an opposite lane of the lane based on the object information;
an occupancy calculating unit configured to calculate occupancy of the lane and occupancy of the opposite lane based on the accumulation capacity of each of objects; and
a cut line setting unit configured to set at least one cut line to the lane and the opposite lane based on the occupancy of the lane and the occupancy of the opposite lane.

2. The system of claim 1, wherein the capacity calculating unit gives traffic capacity of each of objects based on a type, a number and an order of the object and calculates the accumulation capacity of each of objects on the basis of traffic capacity of each of objects.

3. The system of claim 1, wherein the capacity calculating unit gives traffic capacity of each of objects based on a capacity correction factor and calculates the accumulation capacity of each of objects on the basis of traffic capacity of each of objects.

4. The system of claim 3, wherein the capacity calculating unit corrects the accumulation capacity further considering at least one of heavy vehicle ratio, a waiting order for each of lanes, a distribution for each of types of the object, a slope of a road, a linear shape of the road, a branch of the road and a junction of the road.

5. The system of claim 1, wherein the occupancy calculating unit calculates the occupancy corresponding to each of the accumulation capacities based on whether an object corresponding to each of accumulation capacities exists on each of lanes.

6. The system of claim 5, wherein the occupancy calculating unit assigns occupancy corresponding to each of lanes, and calculates the occupancy corresponding to each of accumulation capacities based on occupancy assigned to a lane on which an object corresponding to each of accumulation capacities exists.

7. The system of claim 5, wherein the occupancy calculating unit estimates that an object corresponding to each of accumulation capacities exists when an object corresponding to each of accumulation capacities does not exist but an object corresponding to accumulation capacity greater than each of accumulation capacities exists, and calculates the occupancy depending on the estimating.

8. The system of claim 1, wherein the cut line setting unit calculates total occupancy corresponding to each of accumulation capacities by summating occupancy of the lane corresponding to each of accumulation capacities and occupancy of the opposite lane corresponding to each of accumulation capacities, and sets at least one object corresponding to accumulation capacity, which is more than reference accumulation capacity and its total occupancy is more than specific occupancy, as the at least one cut line.

9. The system of claim 8, wherein the cut line setting unit sets one or more objects corresponding to multiple accumulation capacities, which are more than reference accumulation capacity and their total occupancy is more than specific occupancy, as the at least one cut line.

10. The system of claim 1, further comprising:
a controller configured to set any one of the at least one cut line as a final cut line.

11. The system of claim 10, wherein the controller sets the final cut line based on traffic situation or environment information.

12. The system of claim 11, wherein the environment information includes one or more of a pedestrian waiting line of a crosswalk, arrival of a vehicle group in previous intersection or not, sharp increase of a vehicle or not and information concerning accumulation capacity of another lane.

13. The system of claim 10, wherein the controller generates a control signal for controlling a signal time of a signal controller based on the final cut line.

14. The system of claim 1, further comprising:
a template generating unit configured to generate a first template corresponding to the lane and a second template corresponding to the opposite lane based on the object information, and generate a template by disposing side by side the first template and the second template in a width direction.

15. The system of claim 14, further comprising:
a simulation unit configured to display the generated template and provide a traffic simulation in the template.

16. The system of claim 15, wherein the simulation unit displays the template with a user interface (UI) of setting a cut line.

17. The system of claim 1, wherein the opposite lane includes at least one lane passable at a simultaneous entry signal of an intersection between the lane and the intersection.

18. A method of controlling a traffic signal, the method comprising:
detecting object information based on a lane image;
calculating accumulation capacity of each of objects for respective lane included a lane and an opposite lane of the lane based on the object information;
calculating occupancy of the lane and occupancy of the opposite lane based on the accumulation capacity of each of objects; and
setting at least one cut line to the lane and the opposite lane based on the occupancy of the lane and the occupancy the opposite lane.
